(19) United States
(12) Patent Application Publication
(10) Pub. No.: US 2026/0204726 A1
(43) Pub. Date: Jul. 16, 2026

(54) CASE FOR SECONDARY BATTERY AND SECONDARY BATTERY INCLUDING THE CASE

(71) Applicant: SAMSUNG SDI CO., LTD., Yongin-si (KR)

(72) Inventor: Heejung KO, Yongin-si (KR)

(21) Appl. No.: 19/347,883

(22) Filed: Oct. 2, 2025

(30) Foreign Application Priority Data
Jan. 10, 2025 (KR) 10-2025-0004168

(51) Int. Cl. H01M 50/342; H01M 50/119; H01M 50/159; H01M 50/618; H01M 50/655

(52) U.S. Cl. CPC H01M 50/3425; H01M 50/119; H01M 50/159; H01M 50/618; H01M 50/655; H01M 2200/20

(57) ABSTRACT

A case for a secondary battery includes a body including an accommodation portion configured to accommodate an electrode assembly. A cover is configured to seal an open end of the accommodation portion. An electrolyte injection hole is formed in the body or the cover. A plug is configured to seal the electrolyte injection hole. The plug includes a vent portion configured to rupture when an internal pressure of the sealed accommodation portion exceeds a threshold value.

### CROSS-REFERENCE TO RELATED APPLICATION

The present application claims priority to and the benefit of Korean Application No. 10-2025-0004168, filed on January 10, 2025, in the Korean Intellectual Property Office, the entire disclosure of which is incorporated by reference herein.

### BACKGROUND

### Field

The present disclosure relates to a case for a secondary battery and to a secondary battery including the case.

### Description of the Related Art

Unlike primary batteries that are not designed to be (re)charged, secondary (or rechargeable) batteries can be discharged and recharged. Low-capacity secondary batteries are used in portable, small electronic devices, such as smart phones, feature phones, notebook computers, digital cameras, and camcorders. Large-capacity secondary batteries are widely used as power sources for driving motors in hybrid vehicles and electric vehicles and for storing power (e.g., home and/or utility scale power storage). A secondary battery generally includes an electrode assembly that includes a positive electrode and a negative electrode, a case accommodating the electrode assembly, and electrode terminals connected to the electrode assembly.

When a secondary battery is exposed to a high-temperature environment or when a short circuit occurs, a swelling phenomenon may occur in which gas is generated inside the case due to decomposition of an electrolyte accommodated in the case and electrode reactions. The swelling may cause the case of the secondary battery to bulge. In some situation, the case may rupture, resulting in ignition or explosion due to thermal runaway.

The above information disclosed in this section is for enhancement of understanding of the background of the present disclosure. It may contain information that does not constitute related or prior art.

### SUMMARY

An object to be achieved by the present disclosure is to provide a case for a secondary battery that solves the above-described technical problems and to provide a secondary battery including the case.

These and other aspects and features of the present disclosure will be described in or will be apparent from the following description of embodiments of the present disclosure.

According to an embodiment of the present disclosure, a case for a secondary battery includes a body including an accommodation portion configured to accommodate an electrode assembly, a cover configured to seal an open end of the accommodation portion, an electrolyte injection hole formed in the body or the cover, and a plug configured to seal the electrolyte injection hole, wherein the plug includes a first vent portion configured to rupture when an internal pressure of the sealed accommodation portion exceeds a first threshold value.

In some embodiments, the plug further may include a first flat portion having a shape corresponding to a shape of the electrolyte injection hole, and a wing portion extending from a periphery of the first flat portion, wherein the wing portion may be coupled around the electrolyte injection hole.

In some embodiments, the plug further may include a protrusion configured to be inserted into the electrolyte injection hole, and wherein the first flat portion may be connected to an end of the protrusion.

In some embodiments, the protrusion is configured to contact an inner diameter of the electrolyte injection hole when the protrusion is inserted into the electrolyte injection hole.

In some embodiments, the first vent portion may be formed in the first flat portion.

In some embodiments, the protrusion may include a hollow interior, and wherein the plug may further include a second flat portion configured to seal the hollow interior.

In some embodiments, the second flat portion may include a second vent portion configured to rupture when an internal pressure of the sealed accommodation portion exceeds a second threshold value.

In some embodiments, the wing portion may be bonded around the electrolyte injection hole by an adhesive.

In some embodiments, the wing portion may be welded around the electrolyte injection hole.

In some embodiments, the wing portion may be coupled to an inner surface of the body or an inner surface of the cover.

In some embodiments, the wing portion may be coupled to an outer surface of the body or an outer surface of the cover.

In some embodiments, the plug further may include a stepped portion located between the first flat portion and the wing portion.

In some embodiments, a groove corresponding to the wing portion may be formed around the electrolyte injection hole.

In some embodiments, the first flat portion may include a curved surface that is configured to be recessed toward the electrolyte injection hole.

In some embodiments, the body may include a flange portion extending around the open end of the accommodation portion, and wherein the cover may be configured to be coupled to the flange portion to seal the open end of the accommodation portion.

In some embodiments, the body and the cover may include the same metallic material.

In some embodiments, the metallic material may include stainless steel (SUS).

In some embodiments, a secondary battery includes a case, an electrode assembly accommodated in the case, the electrode assembly including a first electrode, a second electrode, and a separator disposed between the first electrode and the second electrode, wherein the case includes a body including an accommodation portion in which the electrode assembly is accommodated, a cover sealing an open end of the accommodation portion, an electrolyte injection hole formed in the body or the cover, and a plug sealing the electrolyte injection hole, wherein the plug includes a vent portion configured to rupture when an internal pressure of the sealed accommodation portion exceeds a threshold value.

In some embodiments, the secondary battery may further include a first electrode terminal disposed on a side of the body and electrically connected to the first electrode, and a second electrode terminal disposed on a side of the body and electrically connected to the second electrode.

In some embodiments, the vent portion may be formed in a first flat portion of the plug.

According to embodiments of the present disclosure, a case for a secondary battery and a secondary battery including the case that can prevent thermal runaway caused by an increase in internal pressure due to abnormal behavior of the secondary battery may be provided.

According to embodiments of the present disclosure, during a process of injecting an electrolyte into the case accommodating the electrode assembly of the secondary battery and sealing the electrolyte injection hole with the plug, a vent can be formed by only modifying the plug and without employing a separate vent part.

However, aspects and features of the present disclosure are not limited to those described above, and other aspects and features not mentioned will be clearly understood by a person skilled in the art from the detailed description below.

### BRIEF DESCRIPTION OF DRAWINGS

The drawings illustrate embodiments of the present disclosure, and further describe aspects and features of the present disclosure together with the detailed description of the present disclosure. But the present disclosure is not limited to embodiments set forth in the drawings.

FIG. 1 is a schematic diagram of a case for a secondary battery according to an embodiment of the present disclosure.

FIG. 2 illustrates a plug for the case for a secondary battery according to an embodiment of the present disclosure.

FIG. 3 is a cross-sectional view illustrating the plug for the case for a secondary battery and a vicinity of the electrolyte injection hole according to an embodiment of the present disclosure.

FIG. 4 illustrates a plug for the case for a secondary battery according to an embodiment of the present disclosure.

FIG. 5 illustrates a plug for the case for a secondary battery according to an embodiment of the present disclosure.

FIG. 6 illustrates the plug for the case for a secondary battery and a vicinity of the electrolyte injection hole according to an embodiment of the present disclosure.

FIG. 7 is a cross-sectional view of the plug for the case for a secondary battery and a vicinity of the electrolyte injection hole according to an embodiment of the present disclosure.

FIG. 8 is a cross-sectional view of the plug for the case for a secondary battery and a vicinity of the electrolyte injection hole according to an embodiment of the present disclosure.

FIG. 9 is a cross-sectional view of the plug for the case for a secondary battery and a vicinity of the electrolyte injection hole according to an embodiment of the present disclosure.

FIG. 10 is a cross-sectional view of the plug for the case for a secondary battery and a vicinity of the electrolyte injection hole according to an embodiment of the present disclosure.

FIG. 11 is a schematic diagram of a case for a secondary battery according to an embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being "coupled" or "connected" to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or "over" the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being "linked," "coupled," or "connected" to another component, the elements may be directly “coupled,” “linked” or "connected" to each other, or another component may be "interposed" between the components".

Throughout the specification, when "A and/or B" is stated, it means A, B or A and B, unless otherwise stated. That is, “and/or” includes any or all combinations of a plurality of items enumerated. When "C to D" is stated, it means C or more and D or less, unless otherwise specified.

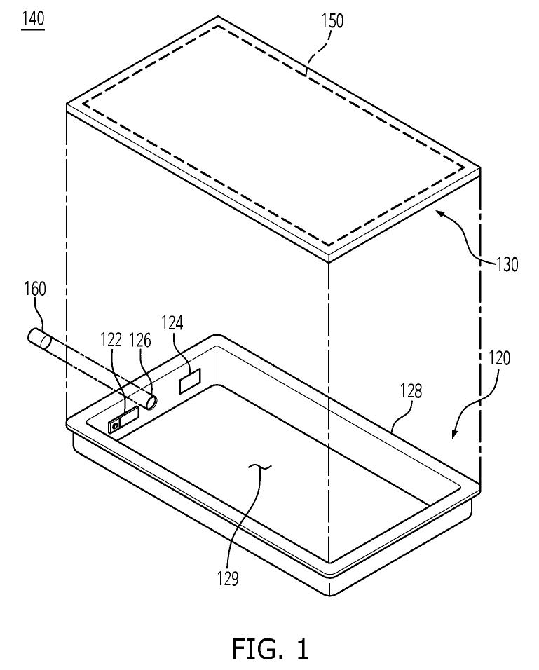

FIG. 1 is a schematic diagram of a case for a secondary battery according to an embodiment of the present disclosure.

Referring to FIG. 1, a case 140 for a secondary battery according to an embodiment of the present disclosure may include a body 120 including an accommodation portion 129 configured to accommodate an electrode assembly. A cover 130 is configured to seal an open end of the accommodation portion 129. An electrolyte injection hole 126 is formed in a side of the body 120 or the cover 130, and a plug 160 is configured to seal the electrolyte injection hole 126.

The case 140 forms the exterior of the secondary battery and may be formed of a conductive metal such as aluminum, an aluminum alloy, or nickel-plated steel. Specifically, the body 120 and the cover 130 may be formed from the same metallic material. The metallic material may include stainless steel (SUS) or aluminum (Al). However, these metals are merely examples, and the case 140 may include various metallic materials that provide the strength required for the secondary battery and resistance to external impacts.

The body 120 may include the accommodation portion 129 having an open end to accommodate the electrode assembly. The accommodation portion 129 of the body 120 may be formed into an internal space in which the electrode assembly is accommodated by press processing or the like. A planar shape of the accommodation portion 129 of the case 140 may be, for example, rectangular. But the present disclosure is not limited thereto.

The body 120 may include a flange portion 128 extending around the open end of the accommodation portion 129. The cover 130 may be coupled to the flange portion 128 to seal the open end of the accommodation portion 129.

Specifically, the cover 130 may be formed as a plate that is disposed on the flange portion 128 of the body 120 to seal the open end of the accommodation portion 129. The cover 130 may be sized such that it covers and contacts the flange portion 128. That is, the lower surface of the cover 130 and the upper surface of the flange portion 128 may contact each other. By coupling the flange portion 128 and the cover 130, the body 120 and the cover 130 may form a single structure.

The case 140 for a secondary battery may include a bonding line 150 disposed on the flange portion 128 and the cover 130 at a position corresponding to the flange portion 128. The bonding line 150 denotes a region where the flange portion 128 and the cover 130 are coupled to each other to seal the accommodation portion 129. In an example, the bonding line 150 may be a welded part where the flange portion 128 and the cover 130 are welded to each other by a laser welder so as to be coupled. The bonding line 150 may include an adhesive-bonded part by which the flange portion 128 and the cover 130 are coupled to each other by an adhesive. The bonding line 150 may be formed along edges of the cover 130 and the flange portion 128.

A width of the flange portion 128 may vary. In other embodiments, the body 120 may not include the flange portion 128. That is, the flange portion 128 in the case 140 is not an essential configuration for coupling the body 120 and the cover 130. The body 120 and the cover 130 may be formed into a single structure by various coupling methods employed in the art in addition or in alternative to a method in which the body 120 and the cover 130 are welded at the bonding line 150 of the flange portion 128. For example, the body 120 and the cover 130 may be coupled by being fitted together.

The case 140 for the secondary battery may further include a first electrode terminal 122 disposed on a side of the body 120 and electrically connected to a first electrode of the electrode assembly and a second electrode terminal 124 disposed on a side of the body 120 and electrically connected to a second electrode of the electrode assembly.

The electrolyte injection hole 126 is a through-hole for injecting an electrolyte into the inside of the case 140. The electrolyte injection hole 120 may connect the sealed accommodation portion 129, in which the body 120 and the cover 130 are joined, to the outside of the accommodation portion 129. After the electrolyte is injected, the electrolyte injection hole 126 may be sealed by the plug 160.

The positions of the electrolyte injection hole 126 and the plug 160 are not limited as long as they are on a side of the body 120 or the cover 130. In FIG. 1, the electrolyte injection hole 126 is shown as being formed on a side of the body 120 so as to be located between the first electrode terminal 122 and the second electrode terminal 124. But the present disclosure is not limited to such positioning. In other examples, the electrolyte injection hole 126 and the plug 160 may be located at a center of the plate constituting the cover 130 or at another side portion of the body 120.

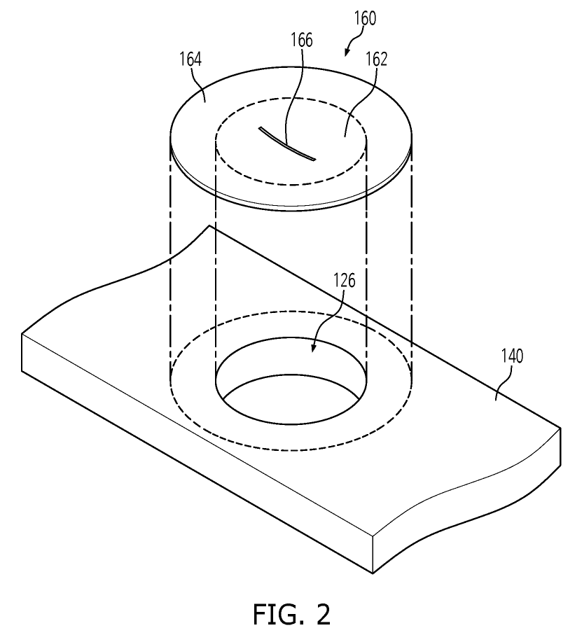

The plug 160 may include a first vent portion 166 (see FIG. 2) configured to rupture when an internal pressure of the sealed accommodation portion 129 exceeds a predetermined first threshold value. The first vent portion may exhaust gas from inside the case 140 and thereby perform a function of adjusting internal pressure. As a result, in a thermal-runaway situation due to an increase in internal pressure caused by abnormal behavior of the secondary battery, the first vent portion may rupture to reduce the internal pressure of the accommodation portion 129. The first vent portion will be described below with reference to FIG. 2 and the like.

During a process of injecting an electrolyte into the case accommodating the electrode assembly of the secondary battery and sealing the electrolyte injection hole with the plug according to embodiments of the present disclosure, a vent can be formed by modifying the plug without employing a separate vent part.

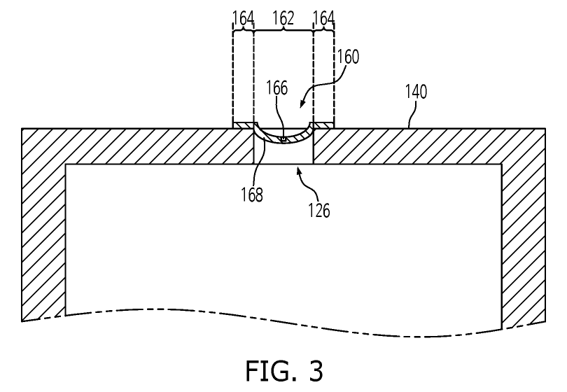

FIG. 2 illustrates a plug of the case for a secondary battery according to an embodiment of the present disclosure. FIG. 3 is a cross-sectional view of the plug for the case for a secondary battery and a vicinity of the electrolyte injection hole according to an embodiment of the present disclosure.

Referring to FIGS. 2 and 3, the plug 160 may include a first vent portion 166 configured to rupture when an internal pressure of the sealed accommodation portion exceeds a predetermined first threshold value. A bonding strength of the first vent portion 166 may be weaker than a bonding strength of other portions of the plug 160. For example, a thickness of a portion where the first vent portion 166 is formed in the plug 160 may be thinner than a thickness of other portions of the plug 160 excluding the first vent portion 166. In another example, a portion where the first vent portion 166 is formed in the plug 160 may be formed from a material having lower pressure resistance than other portions of the plug 160 excluding the first vent portion 166.

The first vent portion 166 may have various shapes. For example, the first vent portion 166 be in the shape of a curve, a straight line, an arc, or a ring. Also, a number of first vent portion 166 in the plug 160 is not limited. A depth of the first vent portion 166 may be adjusted according to a design of the plug 160. In some examples, a depth of the first vent portion 166 may be 30%-90%, 40%-80%, or 50%-60% of a thickness of other portions of the first flat portion 162. The method of forming the first vent portion 166 is not limited and may include various methods commonly employed for forming a vent.

According to an embodiment, the plug 160 may further include a first flat portion 162 having a shape corresponding to a shape of the electrolyte injection hole 126 and a wing portion 164 extending from a periphery of the first flat portion 162. The wing portion 164 may be coupled around the electrolyte injection hole 126. In addition, the first vent portion 166 may be formed in the first flat portion 162.

The first flat portion 162 may denote a flat surface that seals the electrolyte injection hole 126. The first flat portion 162 may have a shape corresponding to the shape of the electrolyte injection hole 126, and the size of the first flat portion 160 may be the same as the electrolyte injection hole 126. Specifically, a planar figure obtained by orthographically projecting the first flat portion 162 may be the same as a planar figure formed by the electrolyte injection hole 126.

The first flat portion 162 may include a curved surface 168 recessed toward the electrolyte injection hole 126. The degree of recess of the curved surface 168 is not limited. In FIG. 3, a shape in which the plug 160 is attached to an outside of the case 140 and recessed inward toward the inside of the case is illustrated. But, in other embodiments, the plug 160 may be shaped to attach to an inside of the case 140 and recess outward toward the outside of the case. In such embodiments, the first vent portion 166 may be formed on the curved surface 168.

The wing portion 164 may allow the plug 160 to be stably mounted to the case 140 for the secondary battery and may provide a sealing function. Here, the wing portion 164 may be coupled around the electrolyte injection hole 126. In the plug 160, the first flat portion 162 and the wing portion 164 may be integrally formed. For example, the plug 160 may be integrally injection-molded so as to have both the first flat portion 162 and the wing portion 164.

Although not illustrated, a groove corresponding to the wing portion 164 may be formed around the electrolyte injection hole 126. Specifically, when the plug 160 is coupled to the electrolyte injection hole 126, the plug 160 may be fitted such that the plug 160 does not protrude beyond a thickness of the electrolyte injection hole 126. In this way, it is possible to prevent the first vent portion 166 located on the first flat portion 162 from rupturing due to an external impact and to improve a function of the plug 160 of sealing an interior of the case 140.

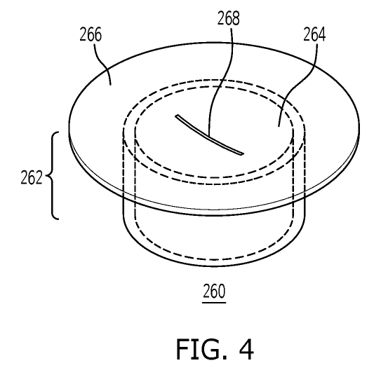

FIG. 4 illustrates a plug for the case for a secondary battery according to another embodiment of the present disclosure. Configurations illustrated in FIG. 4 that have been described above with respect to FIGS. 1-3 are omitted from the following description.

Referring to FIG. 4, a plug 260 according to an embodiment may further include a protrusion 262 that is configured to be inserted into the electrolyte injection hole, a first flat portion 264 connected to one end of the protrusion 262, and a wing portion 266 extending from a periphery of the first flat portion 264. In the orientation shown in FIG. 4, the protrusion 262 is located on a lower side of the plug 260 and may be fitted into the electrolyte injection hole of the case to seal the case.

The first flat portion 264 is connected to an upper portion of the protrusion 262 and may correspond to the shape of the electrolyte injection hole. The first vent portion 268 may be formed in the first flat portion 264.

The wing portion 266 may allow the plug 260 to be stably mounted to the case for a secondary battery and, together with the protrusion 262, may provide an additional sealing function. Here, the wing portion 266 may be coupled around the electrolyte injection hole. The protrusion 262, the first flat portion 264, and the wing portion 266 may all be integrally formed. To this end, the plug 260 may be integrally injection-molded to include the protrusion 262, the first flat portion 264, and the wing portion 266.

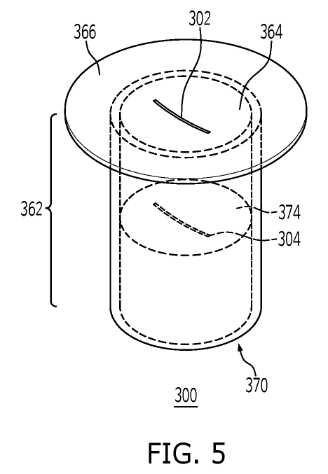

FIG. 5 illustrates a plug for the case for a secondary battery according to an embodiment of the present disclosure.

Referring to FIG. 5, a plug 300 may further include a protrusion 362 configured to inserted into the electrolyte injection hole, a first flat portion 364 connected to one end of the protrusion 362, and a wing portion 366 extending from a periphery of the first flat portion 364. In the orientation shown in FIG. 5, the protrusion 362 is located on a lower side of the plug 300 and may be fitted into the electrolyte injection hole of the case to seal the case. The first flat portion 364 is connected to an upper portion of the protrusion 362 and may correspond to the shape of the electrolyte injection hole. The wing portion 366 may allow the plug 300 to be stably mounted to the case for a secondary battery and, together with the protrusion 362, may provide an additional sealing function.

The protrusion 362 includes a hollow interior 370; that is, the protrusion 362 has a structure in which its central portion thereof is open. Accordingly, the first flat portion 364 can stay sealed to the case when the first vent portion 302 ruptures.

The plug 300 may further include a second flat portion 374 located inside the hollow interior 370 and is configured to seal the hollow interior 370. In this embodiment, the plug 300 may include a first vent portion 302 configured to rupture when an internal pressure of the sealed accommodation portion exceeds a predetermined first threshold value and a second vent portion 304 configured to rupture when the internal pressure of the sealed accommodation portion exceeds a predetermined second threshold value. The first vent portion 302 may be formed on the first flat portion 364, and the second vent portion 304 may be formed on the second flat portion 374.

The bonding strengths of the first vent portion 302 and the second vent portion 304 may be weaker than a bonding strength of other portions of the plug 300. For example, thicknesses of portions where the first vent portion 302 and the second vent portion 304 are formed in the plug 300 may be thinner than thicknesses of other portions of the plug 300. In another example, portions where the first vent portion 302 and the second vent portion 304 are formed in the plug 300 may be formed from a material having lower pressure resistance than other portions of the plug 300. Methods of forming the first vent portion 302 and the second vent portion 304 are not limited and may include various methods employed in the art for forming a vent.

The protrusion 362, the hollow interior 370, the first flat portion 364, the second flat portion 374, and the wing portion 366 may all be integrally formed. To this end, the plug 300 may be injection-molded in one piece so as to integrally include the protrusion 362, the hollow interior 370, the first flat portion 364, the second flat portion 374, and the wing portion 366.

The first threshold value of the first vent portion 302 and the second threshold value of the second vent portion 304 may be different. That is, the first vent portion 302 and the second vent portion 304 may rupture at different times. In an example, the second threshold value of the second vent portion 304, which is relatively closer to an interior of the case, may be less than the first threshold value of the first vent portion 302. In this way, as an internal pressure of the accommodation portion of the case increases, the second vent portion 304 may rupture before the first vent portion 302. Thereafter, the first vent portion 302 may rupture such that a rupture pressure of the overall system can be controlled more delicately.

In another embodiment, the first threshold value of the first vent portion 302 and the second threshold value of the second vent portion 304 may be the same. In a process in which gas generated inside the case of the secondary battery is discharged through the hollow interior 370, the gas may undergo a two-stage vent system including the first vent portion 302 and the second vent portion 304. In this way, it is possible to suppress a rupture from occurring at other portions of the case and to induce discharge of internal gas only through the plug 300.

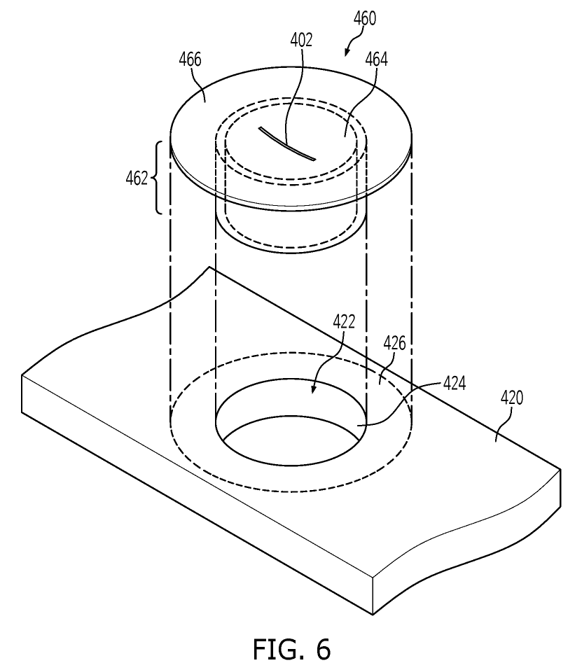

FIG. 6 illustrates the plug for the case for a secondary battery and a vicinity of the electrolyte injection hole according to another embodiment of the present disclosure.

Here, the plug 460 may have the same or similar configuration as the plugs 160 and 300 described above with reference to FIGS. 1 to 5. In an example, the plug 460 may include a protrusion 462 that is configured to be inserted into an electrolyte injection hole 422, a first flat portion 464 connected to one end of the protrusion 462, a wing portion 466 extending from a periphery of the first flat portion 464, and a first vent portion 402 configured to rupture when an internal pressure exceeds a predetermined first threshold value.

Referring to FIG. 6, the protrusion 462 may be in contact with an inner diameter 424 of the electrolyte injection hole 422. That is, the protrusion 462 may be fitted into the electrolyte injection hole 422 formed in the body 420 so as to induce internal sealing of the case. An outer diameter of the protrusion 462 may be at least the same as a length of the inner diameter 424 of the electrolyte injection hole 422. In some embodiments, the protrusion 462 of the plug 460 may be formed of an elastic material.

The wing portion 466 of the plug 460 may be coupled around the electrolyte injection hole 422. The wing portion 466 may allow the plug 460 to be stably mounted to the secondary battery case and, together with the protrusion 462, may provide an internal sealing function for the case. In an example, the wing portion 466 may be bonded around a periphery 426 of the electrolyte injection hole 422 by an adhesive. Additionally or alternatively, the wing portion 466 may be welded around the periphery 426 of the electrolyte injection hole 422. In the present disclosure, the coupling method is not limited, and various joining methods capable of sealing the case may be used. For example, the wing portion 466 and the periphery 426 of the electrolyte injection hole 422 may be joined by laser welding, ultrasonic welding, brazing, laser brazing, welding, soldering, and the like.

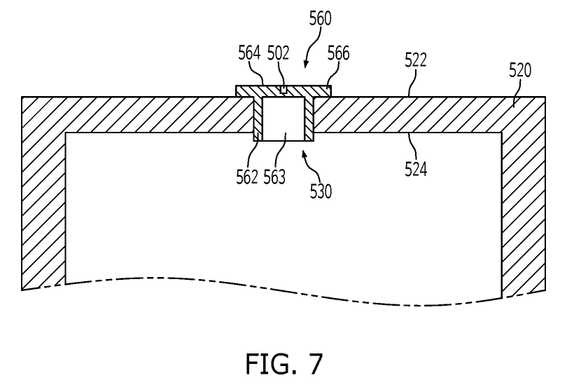

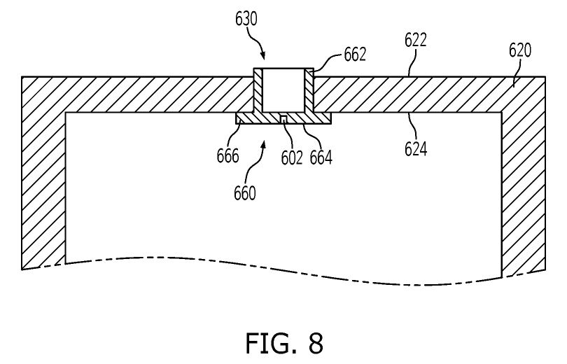

FIGS. 7 and 8 are cross-sectional views of the plug of the case for a secondary battery and a vicinity of the electrolyte injection hole according to embodiments of the present disclosure.

The plugs 560 and 660 may have the same or similar configurations as the plugs 160, 300, and 460 described above with reference to FIGS. 1-6. The plugs 560 and 660 may include protrusions 562 and 662 inserted into electrolyte injection holes 530 and 630, first flat portions 564 and 664 connected to ends of the respective protrusions 562 and 662, wing portions 566 and 666 extending from peripheries of the first flat portions 564 and 664, and first vent portions 502 and 602 configured to rupture when an internal pressure exceeds a predetermined first threshold value.

The protrusion 562 includes a hollow interior 563; that is, the protrusion 562 has a structure in which a central portion is open. Accordingly, when the first vent portion 502 ruptures, the first flat portion 564 can stay sealed to the case.

Referring to FIG. 7, the wing portion 566 according to an embodiment may be coupled to an outer surface 522 of a case exterior 520. Here, the case exterior 520 may denote the exterior of the case including the body 120 and the cover 130 as depicted in FIG. 1. That is, the wing portion 566 may be coupled to an outer surface of the body or an outer surface of the cover. In this configuration, the hollow 563 faces into the interior of the case, and an internal pressure applied to an inner surface 524 of the case exterior 520 is transmitted through the hollow interior 563 to the vent portion 502.

Referring to FIG. 8, the wing portion 666 in another embodiment may be coupled to an inner surface 624 of a case exterior 620. Here, the case exterior 620 may the exterior of the case including the body 120 and the cover 130 as depicted in FIG. 1. That is, the wing portion 666 may be coupled to an inner surface of the body or an inner surface of the cover. In this configuration, an internal pressure applied to the inner surface 624 of the case exterior 620 is directly transmitted to the vent portion 602.

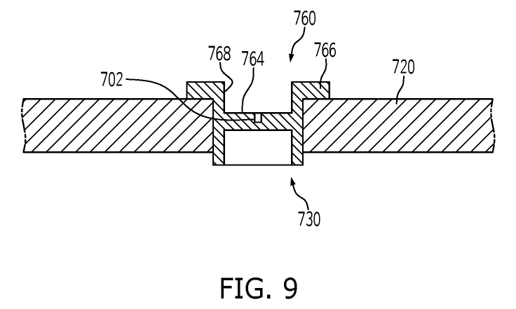

FIG. 9 is a cross-sectional view of the plug for the case for a secondary battery and a vicinity of the electrolyte injection hole according to a further embodiment of the present disclosure.

Referring to FIG. 9, a plug 760 according to an embodiment may further include a stepped portion 768 located between a first flat portion 764 and a wing portion 766. The stepped portion 768 may be concave as illustrated in FIG. 9. The concave stepped portion 768 may prevent the plug 760 from moving in a lateral direction, allow the first flat portion 764 and the protrusion to make multi-surface contact with the electrolyte injection hole 730, and thereby improve the seal of the plug 760. The first flat portion 764 is positioned in an intermediate region of the case exterior 720. Thus, it is possible to prevent the vent portion 702 in the first flat portion 764 from rupturing due to an external impact rather than internal pressure.

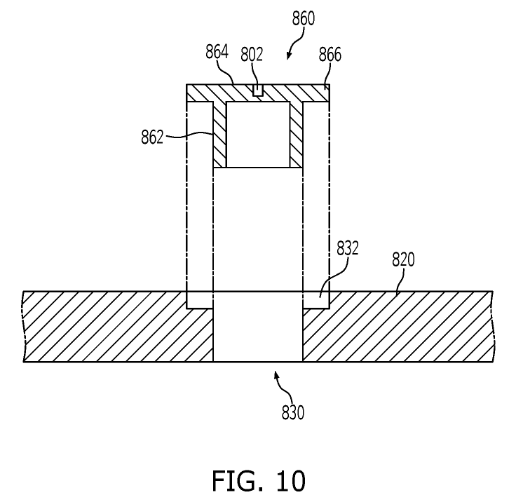

FIG. 10 is a cross-sectional view illustrating the plug for the case for a secondary battery and a vicinity of the electrolyte injection hole according to a further embodiment of the present disclosure.

Referring to FIG. 10, a groove 832 corresponding to a wing portion 866 may be formed around an electrolyte injection hole 830. As such, when the plug 860 is coupled to the electrolyte injection hole 830, the plug 860 may be fitted so as to not protrude beyond the electrolyte injection hole 830. This makes it possible to prevent the vent portion 802 located on the first flat portion 864 from rupturing due to an external impact rather than internal pressure. And, together with the protrusion 862, an internal sealing function of the case may be improved.

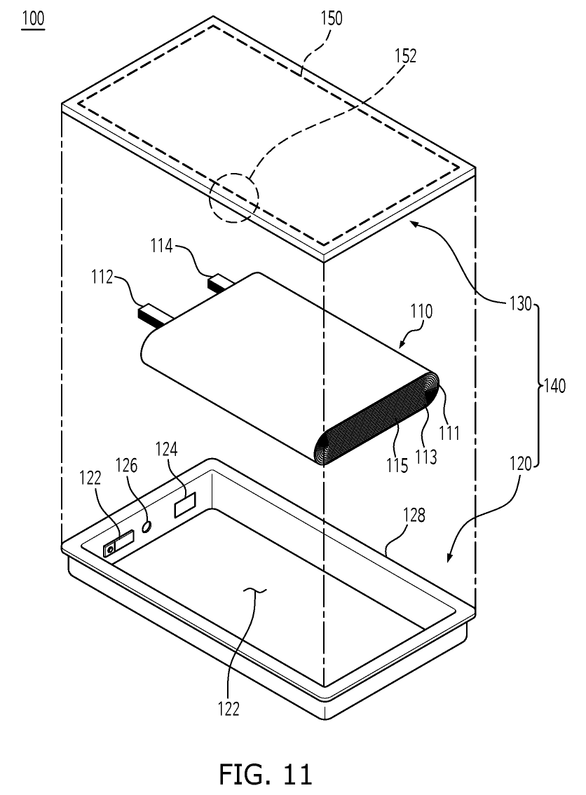

FIG. 11 is a schematic diagram of a secondary battery according to an embodiment of the present disclosure. Configurations illustrated in FIG. 11 that have been described above with respect to FIGS. 1-10 are omitted from the following description.

Referring to FIG. 11, a secondary battery 100 according to an embodiment of the present disclosure may include an electrode assembly 110 including a first electrode 111, a second electrode 113, and a separator 115 disposed between the first electrode 111 and the second electrode 113. The electrode assembly 110 is accommodated in a case 140.

The electrode assembly 110 may be formed by winding or stacking the first electrode 111, the separator 115, and the second electrode 113. For example, the electrode assembly 110 may be formed by winding the first electrode 111, the separator 115, and the second electrode 113 into a jelly-roll shape, with a cavity being formed inside the jelly-roll structure (core portion).

The first electrode 111 may be corresponding to either a positive electrode or a negative electrode in the electrode assembly 110. The second electrode 113 may corresponding to a polarity opposite to that of the first electrode 111. When the first electrode 111 is a positive electrode, the second electrode 113 may be a negative electrode. Conversely, when the first electrode 111 is a negative electrode, the second electrode 113 may be a positive electrode.

The electrode assembly 110 may be impregnated with an electrolyte (not shown). The electrolyte may be, for example, a liquid electrolyte, a solid electrolyte, a gel electrolyte, or a combination thereof.

The secondary battery 100 illustrated in FIG. 11 is a can-type secondary battery made of SUS (stainless steel). But the secondary battery according to the present disclosure is not limited thereto and may be various other types of secondary batteries, such as a prismatic secondary battery made of aluminum.

The secondary battery 100 may be a lithium battery cell, a sodium battery cell, or the like. However, the scope of the present disclosure is not limited with respect to the type of battery, and the secondary battery 100 includes all batteries capable of repeatedly supplying electricity by charging and discharging. In an embodiment, when the secondary battery 100 is a lithium battery cell, it may be used in electric vehicles (EVs) because it has excellent cycle characteristics and high-rate characteristics. For example, it may be used in hybrid vehicles such as a plug-in hybrid electric vehicle (PHEV). In addition, such lithium battery cells may be used in fields in which power storage within various ranges is required, for example, smart phones, tablet PCs, electric bicycles, and electric power tools. But the present disclosure is not limited to these examples.

The positive electrode and the negative electrode are wound after interposing the separator, which is an insulator, between the electrodes. However, the present disclosure is not limited to such a structure, and the electrode assembly may be a structure in which a positive electrode and a negative electrode, each made of a plurality of sheets, are alternately stacked with a separator interposed between each pair of electrodes.

The negative electrode for a rechargeable lithium battery may include a current collector and a negative electrode active material layer on the current collector. The negative electrode active material layer may include a negative electrode active material, and the negative electrode active material layer may further include a binder and/or a conductive material (e.g., an electrically conductive material). For example, the negative electrode active material layer may include about 90 wt% to about 99 wt% of the negative electrode active material, about 0.5 wt% to about 5 wt% of the binder, and about 0 wt% to about 5wt% of the conductive material.

The binder may serve to attach the negative electrode active material particles to each other and also to attach the negative electrode active material to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The conductive material may be used to impart conductivity (e.g., electrical conductivity) to the electrode. Any material that does not cause an undesirable chemical change in a rechargeable lithium battery and conducts electrons can be used in the battery. Examples of the conductive material include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

Aluminum may be used as the current collector. But the present disclosure is not limited to aluminum.

Depending on the type of the rechargeable lithium battery, a separator may be present between the positive electrode and the negative electrode. The separator may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

A negative electrode for a lithium secondary battery may include a current collector and a negative electrode active material layer disposed on the current collector. The negative electrode active material layer may include a negative electrode active material and may further include a binder and/or a conductive material. For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one of copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move. The non-aqueous organic solvent may be a carbonate-based, an ester-based, an ether-based, a ketone-based, an alcohol-based solvent, an aprotic solvent, and may be used alone or in combination of two or more. When a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based heavy antibody or a (meth)acrylic polymer.

The inorganic material may include inorganic particles selected from Al2O3, SiO2, TiO2, SnO2, CeO2, MgO, NiO, CaO, GaO, ZnO, ZrO2, Y2O3, SrTiO3, BaTiO3, Mg(OH)2, boehmite, and combinations thereof. But the present disclosure is not limited to these examples.

The organic material and the inorganic material may be mixed in one coating layer. In other embodiments, the organic material and the inorganic material may be in the form of a coating layer containing an organic material and a coating layer containing an inorganic material that are laminated on each other.

As described above with reference to FIG. 1, the case 140 may include the body 120 including the accommodation portion 129 configured to accommodate the electrode assembly, the cover 130 configured to seal an open end of the accommodation portion 129, the electrolyte injection hole 126 formed on one side of the body 120 or the cover 130, and the plug 160 configured to seal the electrolyte injection hole 126. The plug 160 may include a vent portion configured to rupture when an internal pressure of the sealed accommodation portion 129 exceeds a predetermined first threshold value.

Here, as described above, the plug 160 may further include a protrusion inserted into the electrolyte injection hole 126, a flat portion connected to one end of the protrusion, and a wing portion extending from a periphery of the flat portion, and the wing portion may be coupled around the electrolyte injection hole 126. According to an embodiment, the vent portion may be formed in the flat portion. In addition, the plug 160 may further include a stepped portion located between the flat portion and the wing portion.

The case 140 forms the overall exterior of the secondary battery 100 and may be formed of a conductive metal such as aluminum, an aluminum alloy, or nickel-plated steel. According to embodiments, the case 140 may include a metallic material such as stainless steel (SUS) or aluminum (Al). However, these are merely examples, and the case 140 may include various metallic materials that provided the strength required for the secondary battery 100 and resistance to external impact.

In an embodiment, the secondary battery 100 may further include a first electrode terminal 122 disposed on a side of the body 120 and electrically connected to the first electrode 111 and a second electrode terminal 124 disposed on one side of the body 120 and electrically connected to the second electrode 113. The first electrode terminal 122 and the second electrode terminal 124 may be coupled to the body 120. For example, the first electrode terminal 122 and the second electrode terminal 124 may be disposed on at least one side of the case 140, specifically, on at least one side of the body 120. Positions of the first and second electrode terminals 122 and 124 according to the present disclosure are not limited to the positions illustrated in FIG. 11 and may be in various other positions.

According to embodiments of the present disclosure, a case 140 for a secondary battery and a secondary battery 100 including the case that can prevent thermal runaway caused by an increase in internal pressure due to abnormal behavior of the secondary battery may be provided.

Although the present disclosure has been described above with respect to embodiments thereof, the present disclosure is not limited thereto. Various modifications and variations can be made thereto by those skilled in the art within the spirit of the present disclosure.

### DESCRIPTION OF SOME REFERENCE SYMBOLS

120: body

122: first electrode terminal

124: second electrode terminal

126: electrolyte injection hole

128: flange portion

129: accommodation portion

130: cover

140: case

150: bonding line

160: plug

What is claimed is:

1. A case for a secondary battery comprising:
a body comprising an accommodation portion configured to accommodate an electrode assembly;
a cover configured to seal an open end of the accommodation portion;
an electrolyte injection hole formed in the body or the cover; and
a plug configured to seal the electrolyte injection hole,
wherein the plug comprises a vent portion configured to rupture when an internal pressure of the sealed accommodation portion exceeds a threshold value.

2. The case as claimed in claim 1, wherein the plug further comprises:
a flat portion having a shape corresponding to a shape of the electrolyte injection hole; and
a wing portion extending from a periphery of the flat portion, and
wherein the wing portion is coupled around the electrolyte injection hole.

3. The case as claimed in claim 2, wherein the plug further comprises a protrusion configured to be inserted into the electrolyte injection hole, and
wherein the flat portion is connected to an end of the protrusion.

4. The case as claimed in claim 3, wherein the protrusion is configured to contact an inner diameter of the electrolyte injection hole when the protrusion is inserted into the electrolyte injection hole.

5. The case as claimed in claim 2, wherein the vent portion is formed in the flat portion.

6. The case as claimed in claim 3, wherein the flat portion is a first flat portion,
wherein the protrusion comprises a hollow interior, and
wherein the plug further comprises a second flat portion configured to seal the hollow interior.

7. The case as claimed in claim 6, wherein the vent portion is a first vent portion and the threshold value is a first threshold value, and
wherein the second flat portion comprises a second vent portion configured to rupture when an internal pressure of the sealed accommodation portion exceeds a second threshold value.

8. The case as claimed in claim 2, wherein the wing portion is bonded around the electrolyte injection hole by an adhesive.

9. The case as claimed in claim 2, wherein the wing portion is welded around the electrolyte injection hole.

10. The case as claimed in claim 2, wherein the wing portion is coupled to an inner surface of the body or an inner surface of the cover.

11. The case as claimed in claim 2, wherein the wing portion is coupled to an outer surface of the body or an outer surface of the cover.

12. The case as claimed in claim 2, wherein the plug further comprises a stepped portion located between the flat portion and the wing portion.

13. The case as claimed in claim 2, wherein a groove corresponding to the wing portion is formed around the electrolyte injection hole.

14. The case as claimed in claim 2, wherein the flat portion comprises a curved surface that is configured to be recessed toward the electrolyte injection hole.

15. The case as claimed in claim 1, wherein the body comprises a flange portion extending around the open end of the accommodation portion, and
wherein the cover is configured to be coupled to the flange portion to seal the open end of the accommodation portion.

16. The case as claimed in claim 1, wherein the body and the cover comprise a same metallic material.

17. The case as claimed in claim 16, wherein the metallic material comprises stainless steel (SUS).

18. A secondary battery comprising:
a case; and
an electrode assembly accommodated in the case, the electrode assembly comprising a first electrode, a second electrode, and a separator disposed between the first electrode and the second electrode
wherein the case comprises:
a body including an accommodation portion in which the electrode assembly is accommodated;
a cover sealing an open end of the accommodation portion;
an electrolyte injection hole formed in the body or the cover; and
a plug sealing the electrolyte injection hole,
wherein the plug comprises a vent portion configured to rupture when an internal pressure of the sealed accommodation portion exceeds a threshold value.

19. The secondary battery as claimed in claim 18, further comprising:
a first electrode terminal disposed on a side of the body and electrically connected to the first electrode; and
a second electrode terminal disposed on a one side of the body and electrically connected to the second electrode.

20. The secondary battery as claimed in claim 18, wherein the vent portion is formed in a flat portion of the plug.
